(19) United States
(12) Patent Application Publication
(10) Pub. No.: US 2025/0166071 A1
(43) Pub. Date: May 22, 2025

(54) FEDERATED LEARNING FINANCIAL INTELLECT SERVICE

(71) Applicant: American Express Travel Related Services Company, Inc., New York, NY (US)

(72) Inventor: Srividya Gopalan, Bangalore (IN)

(21) Appl. No.: 18/511,213

(22) Filed: Nov. 16, 2023

(51) Int. Cl. G06Q 40/06; G06Q 20/20; H04L 67/306

(52) U.S. Cl. CPC G06Q 40/06; G06Q 20/209; H04L 67/306

(57) ABSTRACT

Disclosed are various embodiments for a federated learning financial intellect service. In one example, a system comprises a client device configure to identify a purchase of a user profile and transmit transaction data associated with the purchase to a remote computing device for generating snapshot data. The snapshot data is synchronized with the remote computing device based at least in part on a time interval. The snapshot data comprises insight actions applicable to a financial account of the user profile. The client device is configured to identify a request to activate a virtual avatar interface and determine a user state based at least part on a status of the financial account. The client device is configured to determine an insight action to display based at least in part on the current user state and the snapshot data and display the virtual avatar interface to include the insight action.

### BACKGROUND

Individuals have a variety of tools for tracking their financial circumstances. For example, a banking application can be used to track balances of checking and savings accounts. A brokerage application can be used to manage an individual's investment portfolio, such as stocks, bonds, mutual funds, and other investment offerings. A loan website can be used for organizing loan payments, providing loan documents, and providing other loan features.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A and 1B are example drawings of user interfaces displayed on a client device according to various embodiments of the present disclosure.

FIG. 2 is a drawing of a network environment according to various embodiments of the present disclosure.

FIG. 3 is a flowchart illustrating one example of functionality implemented as portions of a client application executed in a client device in the network environment of FIG. 2 according to various embodiments of the present disclosure.

FIG. 4 is a flowchart illustrating one example of functionality implemented as portions of a service executed in a computing device in the network environment of FIG. 2 according to various embodiments of the present disclosure.

FIG. 5 is a flowchart illustrating one example of functionality implemented as portions of a service executed in a computing environment in the network environment of FIG. 2 according to various embodiments of the present disclosure.

### DETAILED DESCRIPTION

The various embodiments of the present disclosure relate to a federated learning financial intellect service. Typically, financial planning software is restricted to helping an individual achieve a specified financial goal based on generic rules and these generic rules are used for all individuals. However, the various embodiments of the present disclosure involve a financial intellect service that can provide unique individual insights after learning about a spending history of an individual. The federated learning financial intellect service can be implemented as a financial avatar or a financial assistant that can provide financial insights (e.g., tailored recommendations and/or analysis, etc.) based at least in part on an individual's financial conditions (e.g., balances of investment accounts, loan accounts, banking accounts, etc.) and/or based at least in part on external financial conditions (e.g., actions taken made by other similar users, rules and regulations imposed by a domestic government, rules and regulations imposed by foreign governments, etc.).

The embodiments address various technical challenges. As an example, the embodiments can be configured to provide an improved approach for generating personalized insights from previous predictive analytic designs by incorporating a larger quantity of data sources and providing more personalized insights based at least in part on user transaction history for the individual user. For example, the embodiments can generate machine learning models based at least in part on financial data sources specific to the user and external data sources for other users and associated external financial market conditions.

In some examples, the embodiments can automatically generate insight notifications for a user without a request from the user. For instance, the embodiments can transmit insight notifications that meet a confidence threshold. As such, the embodiments can be configured to continuously evaluate potential insights based at least in part on whether potential insights have been determined to have a high degree of confidence.

In some examples, the embodiments can be configured for an improved machine learning arrangement by using a federal learning arrangement that incorporates a client device, an edge computing device, and a computing environment. In these examples, the embodiments can involve client devices providing transaction data to the edge computing device, and the edge computing device can use the transaction data for generating a federated model based at least in part the transaction data of the user. The computing environment can receive the federated model from the edge computing system. The computing environment can generate an aggregated model by combining the federated model and a previous aggregated model instance associated with the other users. The aggregated model can be transmitted to the edge computing device. In turn, the edge computing device can transmit insights to the client device based at least in part user profile data associated with a user and the aggregated model. As a result, this approach can address technical challenges relating having sufficient computing resourcing for processing a large quantity of data sources for a machine learning arrangement.

Further, the embodiments provide technical improvements over previous design by generating an interactive virtual avatar or virtual assistant for receiving financial insights requests and providing financial insight responses based at least in part on a machine learning solution. The interactive virtual avatar or assistant can provide an improved user experience by allowing a user to request financial insights from a machine learning solution in a simpler arrangement. The interactive virtual avatar can provide faster and personalized insight responses because of a federated machine learning arrangement. This arrangement can enable the interactive virtual avatar to access to a deployed machine learning model that has been trained on transaction data from the individual user. In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

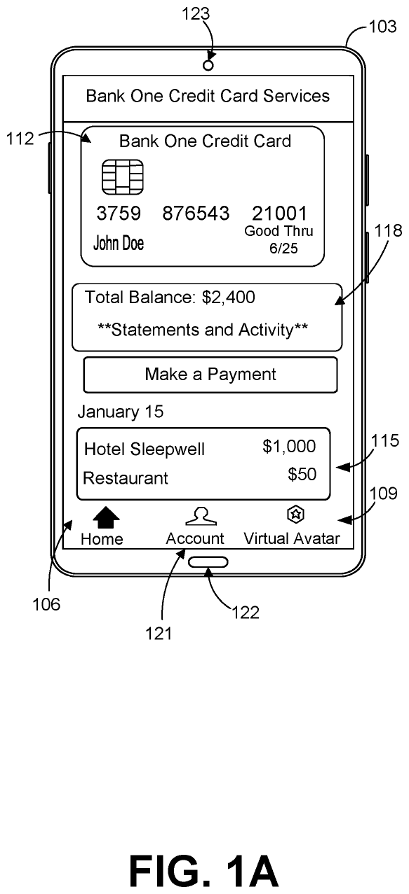

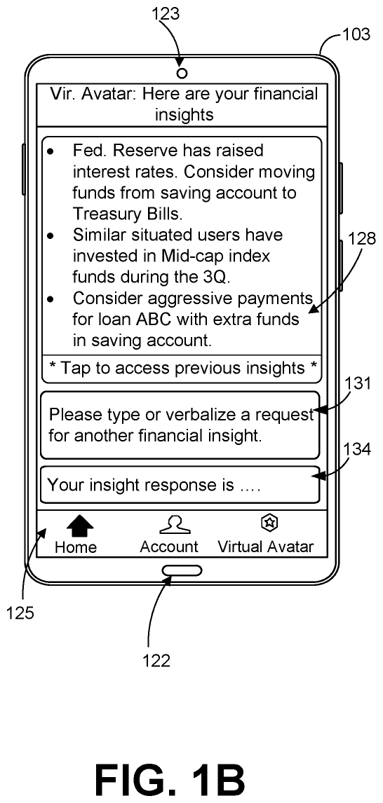

As illustrated in FIG. 1A, shown is a client device 103 that displays a first user interface 106 of a financial service provider for a user with a user account at the financial service provider. The first user interface 106 includes a virtual avatar section 109, a payment instrument section 112, a transaction section 115, a balance section 118, a user account section 121, and other suitable user interface features. The virtual avatar section 109 can be configured to active a virtual avatar interface that provides insights, recommendations, notifications, and other actionable financial information based at least in at part on the internal data sources (e.g., user data) and external data sources (e.g., other similar users, market conditions, etc.). The virtual avatar section 109 can be selected to configure settings associated with the virtual avatar interface. Settings can include enabling/disabling user requests from a microphone 122, audio playback via a speaker 123 of the insights, a time interval for checking with a remote computing device for user insights, and other suitable settings.

The payment instruction section 112 can be used for displaying data regarding one or more payment instruments associated with the user account. The transaction section 115 can be used for displaying user transactions data associated with one or more of the payment instruments. The balance section 118 can be used for displaying balance data associated with the payment instruments. The transaction data and/or the balance data can be provided to a remote computing device as a data source for training a machine learning model for financial insights. The user account section 121 can be used for display user profile data, such as contact information (e.g., email, mailing address, phone number, device identifier, etc.), payment instrument data, and other suitable profile data.

In FIG. 1B, shown is a second user interface 125 that is displayed because of a selection of the virtual avatar section 109 in FIG. 1A. The second user interface 125 can be displayed in response to other triggers such as a selection of an insight notification, an audio command, and other suitable triggers. The second user interface 125 can operate as an interactive interface for a virtual avatar that provides insight actions (e.g., recommendations, etc.), notifications, and other suitable data. The insight actions and notifications can represent an insight or a recommendation associated with achieving a financial objective. The second user interface 125 can include an insight section 128, a request section 131, a response section 134, and other suitable components.

The insight section 128 can include one or more insight actions generated by the virtual avatar. Each insight action can represent a specific task, recommendation, or notification for a user. The insight actions are generated to inform the user of a potential task that the user should consider performing in order to move closer to achieving a financial goal (e.g., user retirement, a savings goal, a net worth goal, etc.).

In some examples, each of the insight actions can be selected in order to provide more details associated with the rationale for the insight actions. For example, a selection of the insight actions can display a user context (e.g., a user conditions associated with the insight actions) and/or and external context. The user context can represent conditions for associated with a current user state, such as a current status of financial account balances, financial goals, and other suitable user information. The external context can refer to domestic financial markets, international financial markets, governmental interest rates, financial actions performed by similar situated users, and other suitable external conditions.

In some examples, upon selection of an insight action, the client device 103 can cause an activation of an instruction for performing a task of the insight action. For example, the insight action may include a recommendation for moving money in a saving account to a loan balance (e.g., auto loan, credit card balance, mortgage loan, etc.). As such, upon selection, a recommended amount of money in the saving account can be transferred to the recommended loan account.

The request section 131 can represent a section for receiving a text input of a request for insight action. In some examples, the request section 131 can be used to trigger a capture of an audible utterance of the request. After the request has been captured, the virtual avatar can process the request by converting the audible utterance into text. The response section 134 can represent a section for displaying a response from the virtual avatar to the request. The response can be displayed via a text format or played via the speaker 123.

In some examples, the user can input a request for an insight action. For example, the request can include an insight category (e.g., investment insight, loan insight, savings insight, etc.). In response to the request, the client application 248 can determine an insight to include in a response based at least in part on the updated snapshot data 245 and/or the user context 230.

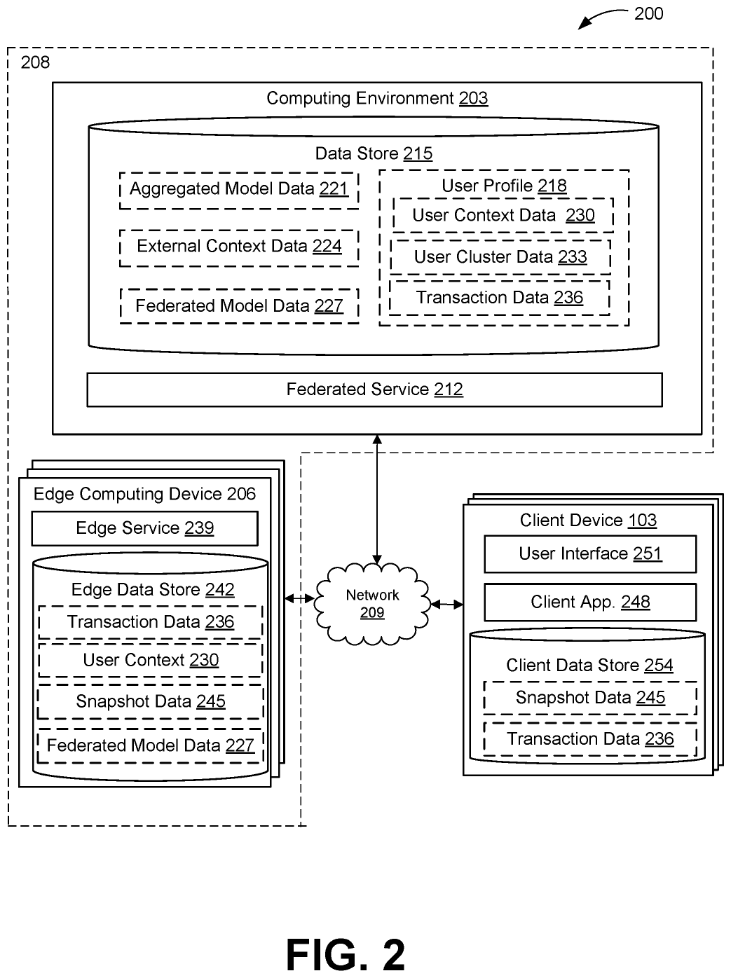

With reference to FIG. 2, shown is a network environment 200 according to various embodiments. The network environment 200 can include a computing environment 203, a client device 103, and an edge computing device 206, which can be in data communication with each other via a network 209. In the context of the present disclosure, a remote computing device 208 can refer to the computing environment 203, the edge computing device 206, a combination of both components, or other suitable arrangements.

The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a federated service 212, and other applications, services, processes, systems, engines, or functionality not discussed in detail herein.

The federated service 212 can be executed to coordinate a federated machine learning solution for generating personalized insights or recommendations (e.g., snapshot data) helping individual users achieve a financial objective based at least in part a specific user data sources and external data sources. The federated service 212 can generate the personalized insights or recommendation data for an interactive virtual avatar executed on the client device 103. The federated service 212 can be in data communication with the edge computing device 206 and the client device 103.

Also, various data is stored in a data store 215 that is accessible to the computing environment 203. The data store 215 can be representative of a plurality of data stores 215, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 215 is associated with the operation of the various applications or functional entities described below. This data can include user profile 218, aggregated model data 221, external context data 224, federated model data 227, and potentially other data.

The user profile 218 can represent user account for an individual user at a financial service provider. Each user profile 218 can include user context data 230, a user cluster data 330, a transaction data 236, and other suitable user data. The user context data 230 can represent data associated with a previous state, a current state, and/or a predicted state of various financial accounts for the user. The financial accounts for the user context data 230 can include, for example, banking account information, investment account information, loan balance information, and other suitable financial information. Additionally, the user context data 330 can also include data relating to one or more financial group specified by the user of the user profile 218.

The user cluster data 233 can represent one or more clusters assigned to the user profile 218 for classification purposes. A user cluster can be determined for the user profile 218 based on location, gender, age, income, occupation, transaction frequency, payment instruments assigned to the user profile 218, and other suitable user classification data. The user cluster data 233 can be used for identifying which aggregated model is applicable to one or more users. As such, the user cluster can be used for determining which aggregated models are transmitted to a particular edge computing device 206 because the edge computing device 206 is associated with particular user clusters or groups of user profiles 218.

The transaction data 236 can represent one or more transactions performed by the user using a payment instrument. The transaction data 236 can include one or more transactions generated by the client device 103, transaction stored in the edge computing device 206, transaction received from merchants, and other suitable transaction. The transaction data 236 can include purchasing information (e.g., transaction amount, location, merchant identifier, purchase category, etc.).

The aggregated model data 221 can represent one or more machine learning models that have been generated by combined multiple machine learning models. For example, the aggregated models can be generated from combining federated models received from the edge computing device 206 and other previous aggregated model instances. The aggregated model data 221 can include aggregated model files, model parameters (e.g., distributed weights, base values), snapshot data of insights, user cluster data, retraining periodically settings, and other suitable model data. The aggregated model data 221 can be generated by executing a federated machine learning algorithm during a training process. In coordination with the edge computing device 206, the federate machine learning algorithm can involve instructing edge services 239 to execute a machine learning algorithm (e.g., a neutral network) on different edge computing datasets stored in edge computing devices 239 without explicitly exchanging or sharing the datasets stored in the computing environment 203 with the edge computing datasets stored in the edge computing device 206. Thus, the edge computing device 206 executes a machine learning algorithm to generate a machine learning model on its own datasets. In some examples, the generated machine learning model can be shared with the federated service 212 in order to form aggregated models, but edge computing device's datasets may not be shared with the federated service 212.

The external context data 224 can represent data associated with external conditions that can be used for generating insights or recommendations. Some non-limiting examples of external conditions can include domestic government market conditions (e.g., interest rates, etc.), investment market perform, foreign government market conditions (e.g., interest rates, etc.), insights actions performed by other similarly situated users (e.g., based at least in part on one or more conditions).

The federated model data 227 can represent one or more machine learning models that have been generated based on the transaction data 236 as the training data set. The federated models can be generated by the edge computing device 206 from the transaction data 236 acquired from a subset of client devices 103 associated with the edge computing device 206. After the edge computing device 206 has generated the federated learning model, the edge computing device 206 can transmit the federated model to the computing environment 203 for aggregation in a federated machine learning arrangement The computing environment 203 can receive the federated models from various edge computing devices 206, which can each have a different subset of client device 103. As a result, the federated models are passed to the computing environment 203 for aggregation for further machine learning process and the training data set of the transaction data 236 may not be passed to the computing environment 203. Thus, this federated machine learning approach can increase the privacy because the computing environment 203 does not require the data sets of the transaction data 236 from the client device 103. In some examples, the federated models sent to the computing environment 203 are encrypted in order to provide increase data security.

The federate model data 227 can include the federated machine learning model file, model parameters (e.g., distributed weights, base values, etc.), snapshot data of insights, user cluster data, retraining periodically settings, and other suitable model data. In some examples, the model parameters for a machine learning neural network are input features, the expected output, the bias for a given scenario, and other suitable model parameters. Input features can be the variable or attributes used to describe the input data. The expected output can be a predicted variable (i.e., a variable that is predicted). Bias can be defined as a constant, which is added to the product of the input. A bias value can determine the influence of input data on the expected output.

In one non-limiting example scenario, a user can consider taking out a personal loan. The federated model data 227 (and/or the aggregated model data 221) can be used by the edge computing service and/or the federated service 212 to generate snapshot data 245, which can include financial insights related to the personal loan of interest for the user. Some non-limiting examples of input features for this scenario can include a loan amount user qualifies for based on a current financial status of the user, loan repayment history of similar situated users for loan amount, loan period, loan interest rate, user affordability of monthly payment, reduction of personal loan fees, current user credit score, and other suitable input features for the above-mentioned scenario.

Some non-limiting examples of an expected output can include a recommended time period for taking out the personal loan, such as a current time window (e.g., between now and the next four weeks), postpone taking out the personal loan for a recommended time period (e.g., three months) based at least in part on one or more conditions (e.g., user financial commitments, external financial events, etc.), and other suitable time periods. Weights and bias can be analyzed and estimated appropriately based at least in part on one or more factors.

The edge computing device 206 can be a computing system that is in data communication with the computing environment 203 and the client device 103. In some embodiments, the edge computing device 206 can be a representative of one or more server-grade computing resources that are geographically located closer to the client device 103 than the computing environment 203. The edge computing device 206 can provide faster data communication (e.g., faster responses) to the client device 103 than the computing environment 203. Various computing processing tasks can be divided between the edge computing device 206 and the computing environment 203.

Various applications or other functionality can be executed in edge computing device 206. The components executed on the edge computing device 206 include an edge service 239, and other applications, services, processes, systems, engines, or functionality not discussed in detail herein.

The edge service 239 can be executed to facilitate the generation of snapshot data (e.g., insight actions). The edge service 239 can be executed to receive transaction data 236 from a subset of client devices 103, generate federated model data 227 based at least in part on the transaction data 236, and provide the federated model data 227 to the computing environment 203.

Also, various data is stored in an edge data store 242 that is accessible to the edge computing device 206. The edge data store 242 can be representative of a plurality of edge data stores 242, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the edge data store 242 is associated with the operation of the various applications or functional entities described below. This data can include the transaction data 236, the user context 230, the federated model data 227, snapshot data 245, and potentially other data. In some examples, the data (e.g., the transaction data 236, the user context 230, etc.) can be stored in cache in the edge data store 242 in order to enable faster memory reads and write operations.

The snapshot data 245 can include one or more insights for user cluster data 233. Each user profile can be assigned to a user cluster 233. The insights can represent actionable course of actions, notifications, recommendations of tasks for achieving a financial goal associated with the financial accounts for the user profile. 218.

The client device 103 is representative of a plurality of client devices that can be coupled to the network 209. The client device 103 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 103 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 103 or can be connected to the client device 103 through a wired or wireless connection.

The client device 103 can be configured to execute various applications such as a client application 248 or other applications. The client application 248 can be executed in the client device to provide financial insights based at least in part on the transaction data 236 associated with a user profile 218. The client application 248 can be executed for operating a virtual avatar interface for providing the financial insights to the user. The client application 248 can be in data communication with the edge computing device 206 and/or the computing environment 203.

Additionally, the client application 248 can be executed in a client device 103 to access network content served up by the computing environment 203 or other servers, thereby rendering a user interface 251 on the display. To this end, the client application 248 can include a browser, a dedicated application, or other executable, and the user interface 251 can include a network page, an application screen, or other user mechanism for obtaining user input. The client device 103 can be configured to execute applications beyond the client application 248 such as email applications, social networking applications, word processors, spreadsheets, or other applications.

Also, various data is stored in a client data store 254 that is accessible to the client device 103. The client data store 254 can be representative of a plurality of client data stores 254, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the client data store 254 is associated with the operation of the various applications or functional entities described below. This data can include snapshot data 245, transaction data 236, and potentially other data.

Next, a general description of the operation of the various components of the network environment 200 is provided. To begin, the client device 103 can have installed a client application 248 that is configured to display a virtual avatar interface for the user. The virtual avatar interface is configured to display financial insights that help a user achieve a financial goal. For example, a user may set a financial goal in the user profile 218 for a saving toward retirement, saving for a down payment of a house, increasing their financial net worth, and other suitable financial goals.

With these financial goals stored in the user profile 218, the virtual avatar interface can display financial insights that will help achieve one or more of the user's financial goals. For example, when requested, the virtual avatar interface can generate a first financial insight for refinancing a high interest rate for a mortgage balance to a lower interest rate because the user's current interest rate is higher than other available interest rates. A second financial insight can include a recommendation to move money in a saving account to a treasury bill because of high interest rates (e.g., derived from a federal reserve interest rate). A third financial insight can include a recommendation for moving money into an alternative mutual funds because of lower expense ratios. A fourth financial insight can indicate that similar situated users are invested in mid-cap equity index funds in the previous financial quarter. In some examples, each of these financial insights can be actionable if selected. For example, the selection of one of the financial insights can facilitate the execution of the selection financial insight.

The financial insights can be stored as snapshot data 245 in the client data store 254. The client application 248 can receive updated snapshot data 245 over time from the edge service 239 or the computing environment 203 based at least in part on a user cluster data 233 and/or a user index associated with the user profile 218 of the user.

The snapshot data 245 can represent data associated insights for helping a user achieve a financial goal. The insights can represent financial recommendations financial notifications, or other suitable. The snapshot data 245 can be generated by machine learning models that are trained on the transaction data 236. Each client device 103 can receive snapshot data 245 associated with a user cluster assigned to the client device 103. Thus, the transaction data 236 provided by each client device 103 can be used to provide personalized financial insights related the transactions submitted by the client device 103.

For instance, the client application 248 can generate transactions for user purchases. The transactions can be generated from purchases with POS devices of merchants (e.g., online merchant POS devices, in-person merchant POS device, etc.), which can be stored as transaction data 236. The transaction data 226 can be transmitted to the edge service 239. The edge service 239 can use the transaction data 236 as training data for a machine learning algorithm to generate federated model data 227. The federated model data 227 can represent patterns, values, coefficients, and other learned developments from the transactions performed by the user. After the federated model data 221 has been generated for a user cluster, the edge service 239 can transmit the federated model data 227 to the federated service 212.

At this point, the federated service 212 can combine the federated model data 227 and previous aggregated model data 221 to generate an update aggregated model data 221. The previous aggregated model data 221 can represent patterns, values, coefficients, and other learned developments derived from the transactions of other users that may be associated with another user cluster. After being generated, the updated aggregated model data 221 can be provided to the edge service 239 based at least in part on the user clusters assigned to the edge service 239. The federated service 212 transmits relevant updated aggregated model data 221 to the edge service 239 based at least in part on the user clusters assigned to the edge service 239. As such, different edge computing devices 206 may receive different aspects of the updated aggregated model data 221.

After being received, the edge service 239 can generate updated snapshot data 245 from the updated aggregated model data 221. The updated snapshot data 245 can include one or more financial insights that include an actionable task for moving a present financial state of the user closer to a financial goal of the user. In some examples, the updated snapshot data 245 can be generated based least in part on the user context 230 or a current user state for a user. For example, the user context 230 can include a current status of financial account balances (e.g., banking accounts, credit card accounts, investment accounts, real estate holdings, loans, other financial obligations, etc.), user income, user geographic location, and other suitable conditions associated with a financial state of the user.

At different instances, the client application 248 can request updated snapshot data 245, and the updated snapshot data 245 can be used for selecting insights for display in the virtual avatar interface. In some examples, the client application 248 can be configured to retrieve or request updated snapshot data 245 on a time interval. Thus, the updated snapshot data 245 can be associated with a time stamp or a period of time.

On the client device, 103, the user can navigate to a virtual avatar interface (e.g., the second user interface 125) and the virtual avatar interface can display personalized insights based at least in part on the updated snapshot data 245. In some examples, the client application 248 can determine which insights to display based at least in part on the user context 230 at a current time period. For example, the current time period of the user context 230 can consider the recent changes in the balances of financial accounts.

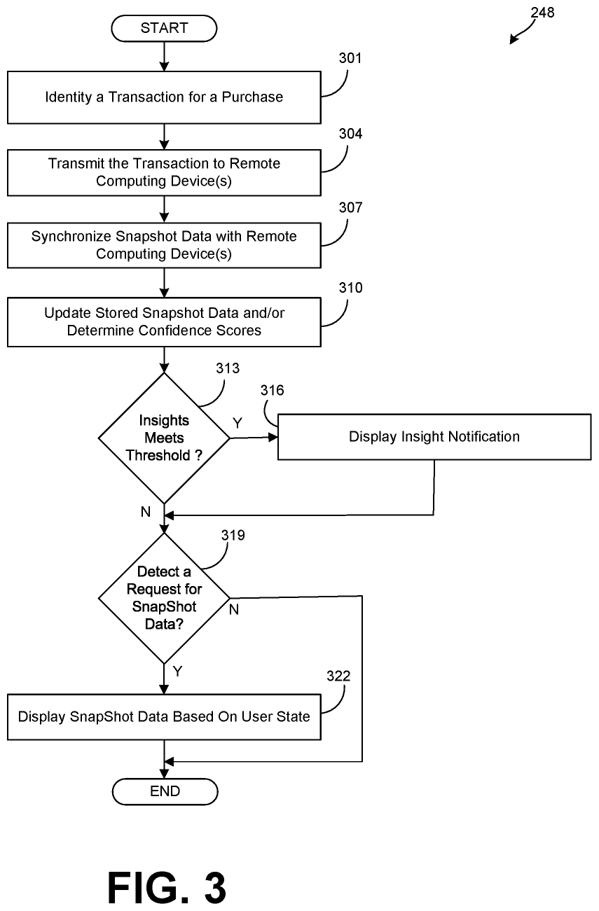

Referring next to FIG. 3, shown is a flowchart that provides one example of the operation of a portion of the client application 248. The flowchart of FIG. 3 provides merely an example of the many different types of functional arrangements that can be employed to implement the operation of the depicted portion of the client application 248. As an alternative, the flowchart of FIG. 3 can be viewed as depicting an example of elements of a method implemented within the network environment 200.

Beginning with block 301, the client application 248 can be executed to identify a transaction of a purchase associated with the user profile 218. The client application 248 can generate transaction data 236 associate with a history of transaction performed on the client device 103. The transaction data 236 can include a list of transactions. In some examples, the client application 248 generates a transaction from an interaction with a point-of-sale device. For example, the transaction can be recorded based at least in part on data (e.g., receipt, authorization code, transaction details, etc.) received from the merchant system, the computing environment 203 or other suitable data.

In block 304, the client application 248 can transmit the transaction data 236 to a remote computing device 208. In some examples, the client application 248 can transmit the transaction data 236 to the edge computing device 206, the computing environment 203, a combination of both, or other suitable computing entities. The transaction data 236 can be transmitted based at least in part on a timing schedule (e.g., a time interval, etc.), upon the generation of each transaction, upon demand, and other suitable triggering arrangements.

In block 307, the client application 248 can synchronize snapshot data 245 with the remote computing device 208. The snapshot data 245 can be synchronized based at least in part on a timing schedule (e.g., a time interval, etc.), upon the generation of update snapshot data 245, upon demand, and other suitable triggering arrangements. In some examples, the synchronization process can first include the client application 248 waking up on a timing schedule (e.g., a time interval, etc.) in order to check with the edge computing device 206 for availability of updated snapshot data 245. The client application 248 can validate system resource status of the edge computing device 206. The client application 248 determine to retrieve the updated snapshot data 245 based at least in part on the availability of the updated snapshot data 245 and/or the validation of the system resource status of the edge computing device 206. In some examples, the client application 248 can retrieve the updated snapshot data 245 by providing a user identifier and/or a user cluster identifier. In response, the edge computing device 206 can transmit the updated snapshot data 245 to the client device 103 based at least in part on the user identifier and/or the user cluster identifier.

In block 310, the client application 248 can update the stored updated snapshot data 245 in memory. The updated snapshot data 245 can be stored in association with a time period or a time stamp. The previous snapshot data instances can be stored in association with previous time periods.

Further, the client application 248 can determine a confidence score associated with the updated snapshot data 245. In some examples, each insight stored in the updated snapshot data 245 can have an individual confidence score. In some instances, the confidence scores can be determined from the aggregated model stored in the edge computing device 206.

In block 313, the client application 248 can determine whether one or more of the insights for the updated snapshot data 245 has a confidence score that meets a threshold. In some embodiments, the threshold can be set to a high degree to identify insights with high confidence scores. If the threshold is met, then the client application 248 can proceed to block 416. If the threshold is not met, then the client application 248 can proceed to block 419.

In block 316, the client application 248 can display an insight notification that includes the insight that met the threshold. In some examples, the client application 248 can display the insight or portions of the updated snapshot data 245 based at least in part on the user context 230 (e.g., a current user state, etc.). Afterwards, the client application 248 can proceed to block 319.

In block 319, the client application 248 can determine whether a request for the updated snapshot data 245 has been detected. In some examples, a detected request can include a selection of the virtual avatar section 109 or a selection of the insight notification from block 416. If a request is detected, then the client application 248 can proceed to block 422. If a request is not detected, then the client application 248 can proceed to the end.

In some examples, the client application 248 can determine a user state based at least in part on a user context 230 (e.g., a current user state). In some instances, the user context 230 can be determined based at least in part on a current status of one or more financial accounts associated with a user profile of the user. The current status can represent a current balance of a financial account, a credit score or status of a financial account, and other suitable financial status indicators.

In block 322, the client application 248 can display the updated snapshot data 245 based at least in part on a user state. The client application 248 can determine the user state based at least in part on the user context 230. In some examples, the updated snapshot data 245 can be displayed in an interactive virtual avatar interface (e.g., the second user interface 125). Each insight displayed in the virtual avatar interface can be associated with a selectable component. Upon selection of the selectable component, the virtual avatar interface can display detailed data of the user context 230 and/or external context data 224 associated with the rationale for the insight. The client application 248 can determine the user state from the user context 230. Then, the client application 248 proceeds to the end.

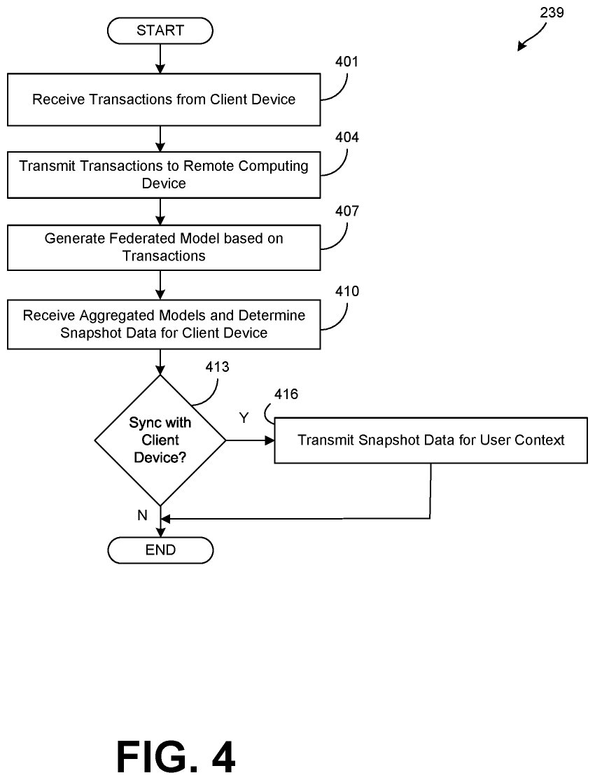

Referring next to FIG. 4, shown is a flowchart that provides one example of the operation of a portion of the edge service 239. The flowchart of FIG. 4 provides merely an example of the many different types of functional arrangements that can be employed to implement the operation of the depicted portion of the edge service 239. As an alternative, the flowchart of FIG. 4 can be viewed as depicting an example of elements of a method implemented within the network environment 200.

Beginning with block 401, the edge service 239 can receive transaction data 236 from the client application 248. The edge service 239 can be in data communication with the client device 103 to configure a schedule for retrieving or receiving transaction data 236. For example, the edge service 239 can instruct the client application 248 to transmit every individual transaction. In other examples, the client application can be instructed to transmit transaction on a time interval.

In block 404, the edge service 239 can transmit the transaction data 236 to the computing environment 203. The transaction data 236 can be transmitted on a schedule (e.g., timing interval, etc.), upon a triggering event, upon demand, or other suitable triggering arrangements.

In block 407, the edge service 239 can generate federated model data 227 based at least in part on the transaction data 236 provided from one or more client devices 103. Among various edge computing devices 206, each edge computing device 206 can receive a different set of transaction data 236 from a different set of client devices 103. The edge service 239 can generate federated models by executing a federated algorithm that is provided the transaction data 236. By executing the federated algorithm, the edge service 239 can generate federated model files, distribute weights, base values, and other modeling parameters.

In some examples, the edge service 239 can initiate the generation of the federated model data 227 based at least in part on an instruction from the federated service 212. For instance, the instruction can include timing (e.g., a timing interval, upon demand, a triggering condition, etc.). for starting the machine learning on the transaction data 236, a type of machine learning algorithm (e.g., neutral network, linear regression, etc.), and other suitable machine learning parameters.

In block 410, the edge service 239 can receive aggregated model data 221 from the computing environment 203. The aggregated model data 221 can include user cluster data 233. The edge service 239 can generate snapshot data 245 from the aggregated model data 221. In some examples, the edge service 239 can generate snapshot data 245 for a specific client device 103 or a subset of client device 103 based at least in part on the user context data 230, the user cluster data 233, and/or other suitable conditions. For example, the edge service 239 can determine a current user state from the user context 230. The current user state may indicate that the user profile 218 has a residence location for the user as Panama City, Florida and that the user profile 218 has one or more loan balances with an interest rate of 10%. Based on this current user state, the edge service 239 can determine that the user profile 218 is assigned to a particular user cluster (e.g., high interest user in Florida, USA). With the user cluster, the edge service 239 can determine a portion of the snapshot data 245 that is relevant to the user profile 218.

In block 413, the edge service 239 can determine whether to synchronize the snapshot data 245 with the client device 103. The edge service 239 can determine whether to synchronize according to a schedule (e.g., a timing interval, etc.), a request from the client device 103, upon a triggering event, and other suitable triggering conditions. If the edge service 239 determines to synchronize, then the edge service 239 proceeds to block 416. If the edge service 239 determines not to synchronize, then the edge service 239 proceeds to the end.

In block 416, the edge service 239 can transmit update snapshot data 245 to a client device 103 of a user profile 218 based at least in part on a determination to synchronize the snapshot data 245 at the client device 103. The edge service 239 can select updated snapshot data 245 to send to the client device 103 based at least in part on the user context 230 for the user profile 218. Then, the edge service 239 can proceed to the end.

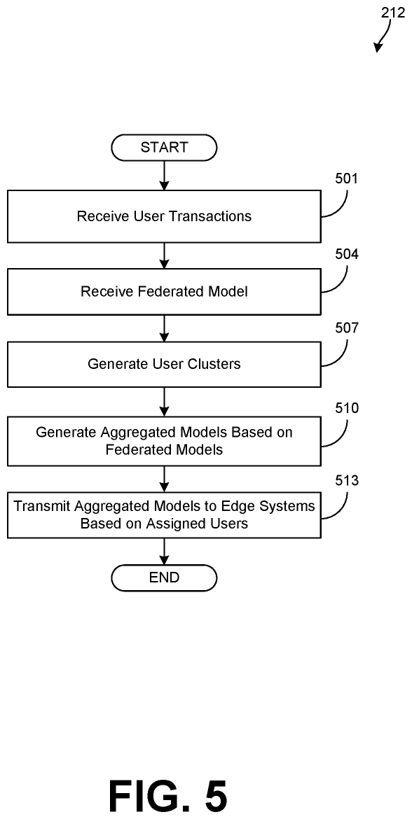

Referring next to FIG. 5, shown is a flowchart that provides one example of the operation of a portion of the federated service 212. The flowchart of FIG. 5 provides merely an example of the many different types of functional arrangements that can be employed to implement the operation of the depicted portion of the federated service 212. As an alternative, the flowchart of FIG. 5 can be viewed as depicting an example of elements of a method implemented within the network environment 200. As another alternative embodiment, the functionality of FIGS. 4 and 5 can be combined and performed by the federated service 212.

Beginning with block 501, the federated service 212 can receive transaction data 236 from the edge service 239 and/or the client application 248. The federated service 212 can configure a communication schedule or triggering conditions for receiving transaction data 236 from the edge service 239 and/or the client application 248. For example, the federated service 212 can instruct the edge service 239 to send a first set of transaction data 236 on a timing interval schedule (e.g., every seven days or other interval of time). Additionally, the federated service 212 can instruct the client application to send a second set of transaction data 236 on a different timing interval schedule. The first set of transaction data 236 can include transactions from subset of client device 103, and the second set of transaction data 236 can include transactions only from the client device 103.

In block 504, the federated service 212 can receive federated model data 227 from the edge service 239. After one or more federated models have been generated, the edge service 239 can transmit the federated model data 227 to the federated service 212.

In block 507, the federated service 212 can generate user cluster data 233 for various user profile 218. For example, the federated service 212 can generate user cluster data 233 based at least in part on one or more conditions, such as user location, gender, age, income, occupation, product purchase history, transaction frequency, banking interactions, payment instrument usage, financial worth index, financial liability index, and other suitable conditions. One or more of the conditions can be used to group the user profiles 218 of users into one or more user clusters.

In some examples, the federated service 212 can determine an index ranking for the user profiles 218 based at least in part on one or more of the above-recited conditions. The index ranking can be used to determine a user cluster for each user profile 218. In some instances, the federate service 212 can determine the index ranking or an index value based at least in part on a simple average, a weighted average, and other suitable index calculations.

In some examples, the federated service 212 can access a user mapping that maps individual user profiles 218 of users to an edge computing device 206. The federated service 212 can execute a cluster algorithm based at least in part on one or more user parameters, such as location, gender, age, income, occupation, product purchase history, transaction frequency, banking interactions, payment instrument usage, financial worth index, financial liability index, user context data 230, and other suitable conditions. For instance, the federated service 212 can generate a first user cluster of user profiles 218 based at least in part on an income threshold (e.g., an accredited investor threshold) and a residence location (e.g., a user within a geographic boundary, a state boundary, a city limits, etc.). In another instance, the federated service can generate a second user cluster of user profiles 218 based at least in part on an age threshold and a residence location.

Each user cluster from the user cluster data 233 can have a list or an index of user profile 218, and the federated service 212 can map the user cluster to an edge computing device 206. In some examples, the federated service 212 identifies transaction data 236 for each user cluster. In this example, the transaction data 236 can include transaction details, such as transaction amount, payment instrument, transaction location, purchase category (e.g., accommodation, travel, school, food, etc.), transaction date, merchant information, and other suitable transaction data. The transaction data 236 for each user cluster can be used for generating updated aggregated model data 221 for the user cluster.

In block 510, the federated service 212 can generate aggregated model 221 based at least in part on the federated model data 227. The federated service 212 can be generated by combining the federated models, previous aggregated models, and external context data 224. The updated aggregated model can include distributed weights and base values associated with the user cluster data 233. In some examples, the federated service 212 can execute a neutral network algorithm that is trained on the federated model data 227, the previous aggregated model data 221, the user cluster data 233, and/or other suitable data. The output of the neutral network algorithm can be an aggregated model.

In some examples, the federated service 212 can provide instructions and coordinate the development of federated models at the edge service 239. For instance, the federated service 212 can execute an initiation of federated learning by selecting a particular type of machine learning algorithm (e.g., neutral network, linear regression, etc.) and other parameters for the edge services 239 to use for training on their transaction data 236. The federated service 212 can select which edge services 239 (e.g., associated with an edge computing device 206) to activate for local machine learning training. In some instances, the selection is based at least in part on a time interval, a triggering condition, and other suitable conditions. The federated service 212 can transmit an instruction to the selected edge services 239 begin developing a federated model in response to the instruction. After the federated model has been developed, the edge service 239 can send the federated model to the federated service 212, which can represent an end of a round of iterative federated learning.

In some examples, the federated service 212 can specify one or more federated learning parameters. Some non-limiting examples of federated learning parameters can include a number of federated learning rounds, a total number of edge computing device 239 used for a federated learning round, and other suitable federated learning parameters.

In block 513, the federated service 212 can transmit the aggregated model 221 to the edge computing device 206 based at least in part on the user profiles 218 or user clusters assigned to the edge computing device 206. For example, the federated service 212 can determine to transmit a first aggregated model to a first edge computing device 206 because the first edge computing device 206 is associated with a first user cluster of client devices 103. The first aggregated model can be trained to provide snapshot data 245 for the first user cluster. The federated service 212 can transmit a second aggregated model to a second edge computing device 206 because the second edge computing device 206 is associated with a second user cluster of client device 103. The second aggregated model can be trained to provide snapshot data 245 for the second user cluster.

In some examples, the federated service 212 can determine triggering conditions for initiating a retraining of the aggregated model. The triggering conditions can include a timing interval schedule (e.g., retrain the models every five days or at another interval of time), upon a request, upon a triggering event, and other suitable triggering conditions.

In some examples, the federated service 212 retrieve or receive client application data from one or more client device 103. Based on the client application data, the federated service 212 can determine application usage data, such as application usage frequency, application intensity (e.g., a length of application usage sessions, etc.), usage frequency of specific application features, and other suitable application usage data. The federated service 212 can determine a communication priority for user profiles 218 based at least in part on the application usage data and the transaction data 236. The communication priority can indicate a frequency on which the edge service 239 is likely to provide updated snapshot data 245 to the client application 238. The communication priority can also represent a priority ranking for communicating updated snapshot data 245. In some examples, the communication priority can be assigned to each of the edge computing devices 206 based at least in part on the user cluster data 233 associated with the edge computing device 206. The federated service 212 can prioritize or determine a communication queue for transmitting the updated aggregated model data 221 to each of the edge computing devices 206 based at least in part on the communication priority. Then, the federated service 212 can proceed to the end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts FIGS. 3-5 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts of FIGS. 3-5 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts of FIGS. 3-5 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a client device comprising a processor and a memory; and
machine-readable instructions stored in the memory that, when executed by the processor, cause the client device to at least:
identify a purchase for a user profile associated with the client device;
transmit transaction data associated with the purchase to a remote computing device for generating snapshot data;
synchronize the snapshot data assigned to the user profile with the remote computing device based at least in part on a time interval, where the snapshot data comprises a plurality of insight actions applicable to a plurality of financial accounts of the user profile;
identify a request to activate a virtual avatar interface;
determine a current user state based at least part on a current status of the plurality of financial accounts associated with the user profile;
determine an insight action from the plurality of insight actions to display based at least in part on the current user state and the snapshot data; and
display the virtual avatar interface to include the insight action.

2. The system of claim 1, wherein the purchase is identified based at least in part on a generation of the transaction data from an interaction with a point-of-sale (POS) device.

3. The system of claim 1, wherein the machine-readable instructions further cause the client device to at least:
identify another request for a previous insight action from the virtual avatar interface;
retrieve previous snapshot data associated with a previous time period from the memory; and
display a previous insight action in the virtual avatar interface.

4. The system of claim 1, wherein the time interval is a first time interval and the machine-readable instructions further cause the client device to at least:
determine a second time interval has expired for the snapshot data;
transmit a snapshot request to the remote computing device based at least in part on the expiration of the second time interval, wherein the snapshot request comprises a user cluster assigned to the user profile; and
receive updated snapshot data associated with the user cluster from the remote computing device.

5. The system of claim 1, wherein the remote computing device is an edge computing device that is data communication with a computing environment and the client device.

6. The system of claim 1, wherein the time interval is a first time interval and the machine-readable instructions further cause the client device to at least:
determine a second time interval has expired for the snapshot data;
validate a computing resource status associated with the remote computing device based at least in part on the expiration of the second time interval; and
retrieve updated snapshot data from the remote computing device based at least in part on the validation of the computing resource status.

7. The system of claim 1, wherein the machine-readable instructions further cause the client device to at least:
receive a selection of the insight action from the virtual avatar interface; and
transmit an instruction for executing the insight action to the remote computing device based at least in part in part on the selection of the insight action.

8. A method, comprising:
identifying, by a client device, a purchase for a user profile associated with the client device;
transmitting, by the client device, transaction data associated with the purchase to a remote computing device for generating snapshot data;
synchronizing, by the client device, the snapshot data assigned to the user profile with the remote computing device based at least in part on a time interval, where the snapshot data comprises a plurality of insight actions applicable to a plurality of financial accounts of the user profile;
identifying, by the client device, a request to activate a virtual avatar interface;
determining, by the client device, a current user state based at least part on a current status of the plurality of financial accounts associated with the user profile;
determining, by the client device, an insight action from the plurality of insight actions to display based at least in part on the current user state and the snapshot data; and
displaying, by the client device, the virtual avatar interface to include the insight action.

9. The method of claim 8, wherein the purchase is identified based at least in part on a generation of the transaction data from an interaction with a point-of-sale (POS) device.

10. The method of claim 8, further comprising:
identifying, by the client device, another request for a previous insight action from the virtual avatar interface;
retrieving, by the client device, a previous snapshot data associated with a previous time period from a memory of the client device; and
displaying, by the client device, a previous insight action in the virtual avatar interface.

11. The method of claim 8, the time interval is a first time interval and the method further comprising:
determining, by the client device, a second time interval has expired for the snapshot data;
transmitting, by the client device, a snapshot request to the remote computing device based at least in part on the expiration of the second time interval, wherein the snapshot request comprises a user cluster assigned to the user profile; and
receiving, by the client device, updated snapshot data associated with the user cluster from the remote computing device.

12. The method of claim 8, wherein the remote computing device is an edge computing system that is data communication with a computing environment.

13. The method of claim 8, the time interval is a first time interval and the method further comprising:
determining, by the client device, a second time interval has expired for the snapshot data;
validating, by the client device, a computing resource status associated with the remote computing device based at least in part on the expiration of the second time interval; and
retrieving, by the client device, updated snapshot data from the remote computing device based at least in part on the validation of the computing resource status.

14. The method of claim 8, further comprising:
receiving, by the client device, a selection of the insight action from the virtual avatar interface; and
transmitting, by the client device, an instruction for executing the insight action to the remote computing device based at least in part in part on the selection of the insight action.

15. A system, comprising:
an edge computing device comprising a processor and a memory;
machine-readable instructions stored in the memory that, when executed by the processor, cause the edge computing device to at least:
receive transaction data from a client device;
generate a federated machine learning model based at least in part on the transaction data;
transmit the federated machine learning model to a remote computing device;
receive an aggregated machine learning model from the remote computing device, wherein the aggregated machine learning model representing a combination of the federated machine learning model and a previous aggregated machine learning model.
generate snapshot data for the client device based at least in part on the aggregated machine learning model and a user context associated with the client device, the snapshot data comprising a plurality of insight actions applicable to a financial account associated with the client device; and
synchronize the snapshot data with the client device based at least in part on a time interval, the snapshot data being configured for use by a virtual avatar interface to present one of the plurality of insight actions.

16. The system of claim 15, wherein the federate machine learning model is generated from a plurality of transactions associated with the client device.

17. The system of claim 15, wherein generating the snapshot data for the client device further cases the edge computing device to at least:
identify a list of user profiles associated with the edge computing device; and
generating the snap data for the list of user profiles.

18. The system of claim 15, wherein generating the snapshot data for the client device further cases the edge computing device to at least:
identify a user context associated with a user profile of the client device; and
select the snapshot data from the aggregated machine learning model based at least in part on the user context.

19. The system of claim 18 wherein identify the user context further causes the edge computing device to at least:
identify a balance of the financial account associated with the user profile;
identify a financial objective for the user profile; and
wherein the snapshot data is generated based at least in part on the balance of the financial account and the financial objective.

20. The system of claim 15, wherein the federated machine learning model is generated based at least in part on the transaction data that has occurred within a time period and retrieved from cache memory of the edge computing device.
